(19) United States
(12) Patent Application Publication
(10) Pub. No.: US 2009/0313239 A1
(43) Pub. Date: Dec. 17, 2009

(54) Adaptive Visual Similarity for Text-Based Image Search Results Re-ranking

(75) Inventors: Fang Wen, Beijing (CN); Xiaoou Tang, Beijing (CN)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/140,244

(22) Filed: Jun. 16, 2008

(51) Int. Cl. G06F 17/30

(52) U.S. Cl. 707/5; 707/E17.019

(57) ABSTRACT

Described is a technology in which images initially ranked by some relevance estimate (e.g., according to text-based similarities) are re-ranked according to visual similarity with a user-selected image. A user-selected image is received and classified into an intention class, such as a scenery class, portrait class, and so forth. The intention class is used to determine how visual features of other images compare with visual features of the user-selected image. For example, the comparing operation may use different feature weighting depending on which intention class was determined for the user-selected image. The other images are re-ranked based upon their computed similarity to the user-selected image, and returned as query results. Retuning of the feature weights using actual user-provided relevance feedback is also described.

### BACKGROUND

One of the things that users can search for on the Internet is images. In general, users type in one or more keywords, hoping to find a certain type of image. An image search engine then looks for images based on the entered text. For example, the search engine may return thousands of images ranked by the text keywords that were extracted from image filenames and the surrounding text.

However, contemporary commercial Internet-scale image search engines provide a very poor user experience, in that many of returned images are irrelevant. Sometimes this is a result of ambiguous search terms, e.g., “Lincoln” may be referring to the famous Abraham Lincoln, the brand of automobile, the capital city in the state of Nebraska, and so forth. However, even when less ambiguous, the semantic gap between image representations and their meanings makes it very difficult to provide good results on an Internet-scale database contaminated with many irrelevant images. The use of visual features in ranking images by relevance may help, but heretofore costs too much in time and space to be used in Internet-scale image search engines.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a user-selected image is received (e.g., a “query image” selected from text-ranked image search result), classified into an intention class and compared against other images for similarity, in which the comparing operation that is used depends on the intention class. For example, the comparing operation may use different feature weighting depending on which intention class was categorized. The other images are re-ranked based upon their computed similarity to the user-selected image.

In one aspect, there is described receiving data corresponding to a set of images and one selected image. The selected image is classified into an intention class that is in turn used to choose a comparison mechanism (e.g., one set of feature weights) from among plurality of available comparison mechanisms (e.g., other feature weight sets). Each image is featurized, with the chosen comparison mechanism used in comparing the features to determine a similarity score representing the similarity of each other image relative to the selected image. The images may be re-ranked according to each image's associated similarity score, and returned as re-ranked search results.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an example Internet search environment in which images are searched and re-ranked for likely improved relevance based on user selection.

FIG. 2 is a block diagram representing an example adaptive image post processing mechanism for re-ranking images based on user selection.

FIG. 3 is a flow diagram showing example steps taken to re-rank images based on a query image classification and image features.

FIG. 4 is a block diagram representing re-tuning the model based on actual user feedback as to relevance.

FIG. 5 shows an illustrative example of a computing environment into which various aspects of the present invention may be incorporated.

### DETAILED DESCRIPTION

Various aspects of the technology described herein are generally directed towards re-ranking text-based image search results based on visual similarities among the images. After receiving images in response to a keyword query, a user can provide a real-time selection regarding a particular image, e.g., by clicking on one image to select that image as the query image (e.g., the image itself and/or an identifier thereof). The other images are then re-ranked based on a class of that image, which is used to weight a set of visual features of the query image relative to those of the other images.

It should be understood that any examples set forth herein are non-limiting examples. For example, the features and/or classes that are described and used herein to characterize an image are only some features and/or classes that may be used, and not all need be used. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing, networking and content retrieval in general.

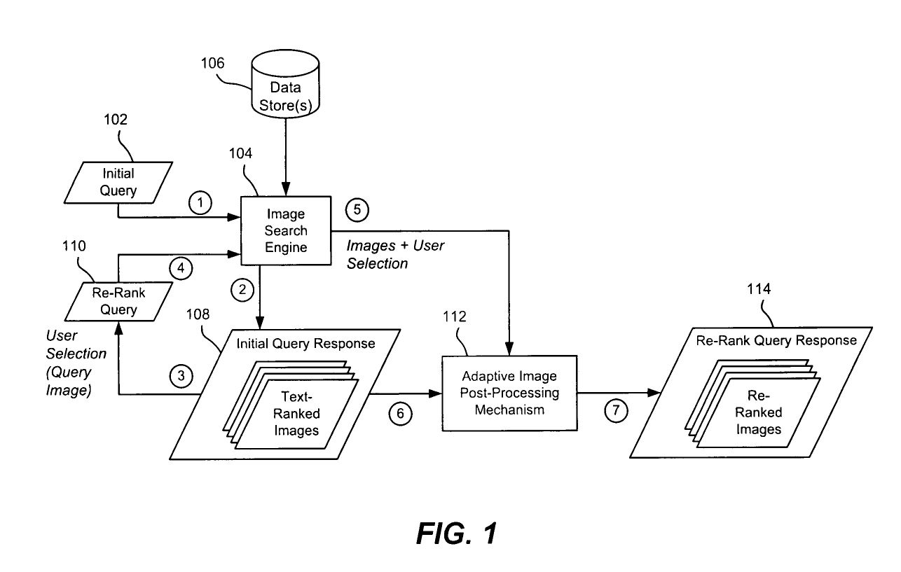

As generally represented in FIG. 1, there is shown an Internet image search environment, in which a client (user) submits an initial query 102 to an image search engine 104, as generally represented by the arrow labeled with circled numeral one (1). As is known, the image search engine 104 accesses one or more data stores 106 and provides a set of images 108 in response to the initial query 102 (circled numeral two (2)). The images are ranked for relevance based on text.

As generally represented by the arrow labeled with circled numerals three (3) and four (4), the user may provide a selection to the image search engine 104 via a re-rank query 110. Typically this is done by selecting a “query image” as the selection, such as by clicking on one of the images in a manner that requests a re-ranking.

When the search engine 104 receives such a re-rank query 110, the image search engine invokes an adaptive image post-processing mechanism 112 to re-rank the initial results (circled numerals five (5) and six (6)) into a re-rank query response 114 that is then returned as re-ranked images (circled numeral seven (7)).

In one example implementation, the re-ranking is based on a classification of the query image (e.g., scenery-type image, a portrait-type image and so forth) as described below. Note however, that the user selection may include more than just the query image, e.g., the user may provide the intention classification itself along with the query image, such as from a list of classes, to specify something like “rank images that look like this query image but are portraits rather than this type of image;” this alternative is not described hereinafter for purposes of brevity, instead leaving classification up to the adaptive image post-processing mechanism 112.

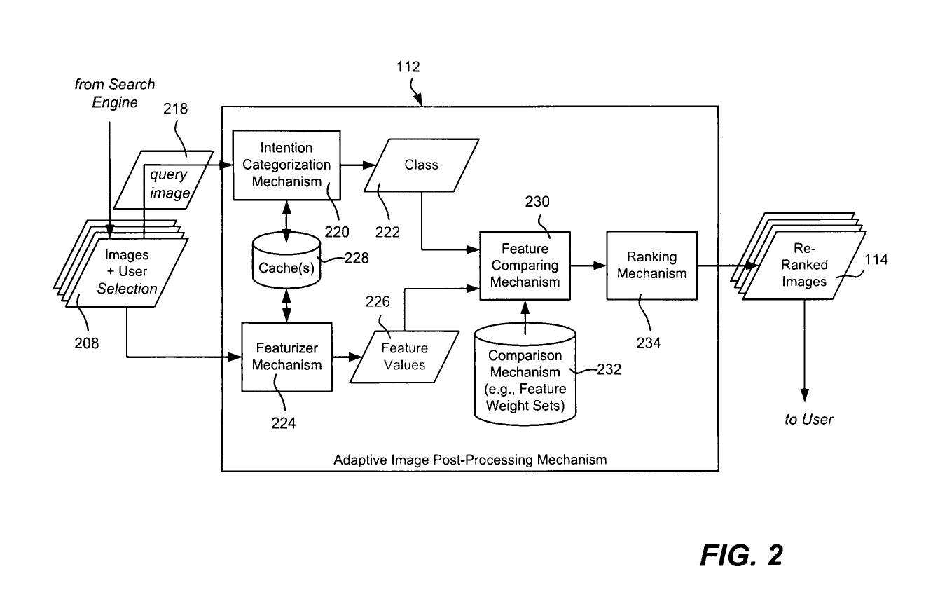

In general, the adaptive image post-processing mechanism 112 includes a real-time algorithm that re-ranks the returned images according to their similarities with the query. More particularly, as represented in FIG. 2, the search engine sends image data and the user selection (e.g., the query image) to the adaptive image post-processing mechanism 112. Note that the images themselves need not be sent, but rather identifiers as long as the images can be processed as appropriate.

As represented in FIG. 2, the images/user selection 208 include a query image 218 that may be categorized by an intention categorization mechanism 220 according to a set of predefined “intentions”, such as into a class 222 from among those classes of intentions described below. Further, the query image 218 may be processed by a featurizer mechanism 224 into various features values 228, such as those described below. Note that the classification and/or featurization may be done dynamically as needed, or may be pre-computed and retrieved from one or more caches 228. For example, a popular image that is often selected as a query image may have its class and/or feature values saved for more efficient operation.

The other images are similarly featurized into their feature values. However, instead of directly comparing these feature values with those of the query image to determine similarity with the query image 218, the features are first weighted relative to one another based on the class. In other words, a different comparison mechanism (e.g., different weights) is chosen for comparing the features for similarity depending into which class the query image was categorized, that is, the intent of the query image. To this end, a feature comparing mechanism 230 obtains the appropriate comparison mechanism 232 (e.g., a set of feature weights stored in a data store) from among those comparison mechanisms previously trained and/or computed. A ranking mechanism 234, which may operate as the various other images are compared with the query image, or sort the images afterwards based on associated scores, then provides the final re-ranked results 114.

Turning to the concept of class-based feature weights, intentions reflect the way in which different features may be combined to provide better results for different categories of images. Image re-ranking is adjusted differently (e.g., via different feature weights) for each intention category. Actual results have proven that by classifying images differently, overall retrieval performance with respect to relevance is improved.

In order to characterize images from different perspectives, such as color, shape, and texture, an example set of features is described herein. These features are effective in describing the content of the images, and efficient to use in terms of their computational and storage complexity. However, less than all of these exemplified features may be used in a given model, and/or other features may be used instead of or in addition to these example features.

One feature that describes the color composition of an image is generally referred to as a color signature. To this end after k-Means clustering on pixel colors in LAB color space, the cluster centers and their relative proportions are taken as the signature. One known color signature that accounts for varying importances of different parts of an image is referred to as Attention Guided Color Signature (ASig); an attention detector may be used to compute a saliency map for the image, with k-Means clustering weighted by this map performed. The distance between two ASigs can be calculated efficiently using a known (e.g., Earth Mover Distance, or EMD) algorithm.

Another (and believed new) feature, a “Color Spatialet” feature, is used to characterize the spatial distribution of colors in an image. To this end, an image is first divided into n×n patches by a regular grid. Within each patch, the patch's main color is calculated as the largest cluster after k-Means clustering. The image is characterized by Color Spatialet (CSpa), a vector of n² color values; in one implementation, n=9. The following may be used to account for some spatial shifting and resizing of objects in the images when calculating the distance of two CSpas A and B:

$$d ( A , B ) = {\sum }_{i = 1}^{n} {\sum }_{j = 1}^{n} min [ d ( {A}_{i , j} , {B}_{i \pm 1 , j \pm 1} ) ] \qquad ( 1 )$$

where A_{i,j} denotes the main color of the (i,j)th block in the image.

Gist is a known way to characterize the holistic appearance of an image, and may thus be used as a feature, such as to measure the similarity between two images of natural scenery. Gist can project images which share similar semantic scene categories together.

Daubechies Wavelet is another feature, based on the second order moments of wavelet coefficients in various frequency bands to characterize textural properties in the image. More particularly, the Daubechies-4 Wavelets Transform (DWave) is used, which is characterized by a maximal number of vanishing moments for some given support.

SIFT is a known feature that also may be used to characterize an image. More particularly, local descriptors are demonstrated to have superior performance on object recognition tasks. Known typical local descriptors include SIFT, and Geometric Blur. In one implementation, 128-dimension SIFT is used to describe regions around Harris interest points. A codebook of 450 words is obtained by hierarchical k-Means on a set of 1.5 million SIFT descriptors extracted from a randomly selected set of 10,000 images from a database. The descriptors inside each image are then quantized by this codebook. The distance of two SIFT features can be calculated using tf-idf (term frequency-inverse document frequency), which is a common approach in information retrieval to take into account the relative importance of words.

Multi-Layer Rotation Invariant Edge Orientation Histogram (MRI-EOH), which describes a histogram of edge orientations, has long been used in variance vision applications due to its invariance to lighting change and shift. Rotation invariance is incorporated when comparing two EOHs, resulting in a Multi-Layer Rotation Invariant EOH (MRI-EOH). To calculate the distance between two MRI-EOHs, one of them is rotated to best match the other, and take this distance as the distance between the two. In this way, rotation invariance is incorporated to some extent. Note that when calculating MRI-EOH, a threshold parameter is used to filter out the weak edges; one implementation uses multiple thresholds to get multiple EOHs to characterize image edge distribution on different scales.

Another feature is based on Histogram of Gradient (HoG), which is known as the histogram of gradients within image blocks divided by a regular grid. HoG reflects the distribution of edges over different parts of an image, and is especially effective for images with strong long edges.

With respect to facial features, the existence of faces and their appearances give clear semantic interpretations of the image. A known face detection algorithm may be used on each of the images to obtain the number of faces, face size and position as the facial feature (Face) to describe the image from a “facial” perspective. The distance between two images is calculated as the summation of differences of face number, average face size, and average face position.

With this set of features characterizing images from multiple aspects, the features may be combined to make a decision about similarity sᵢ (•) between the query image and any other image. However, combining different features together is nontrivial. Consider that there are F different features to characterize an image. The similarity between image i and j on feature m is denoted as s^{m} (i,j). A vector αi is defined for each image i to express its specific “point of view” towards different features. The larger αiₘ is, the more important the mth feature will be for image i. Without losing generality, a constraint is that α≧0 and ∥α1∥=1, providing the local similarity measurement at image i:

$${s}_{i} ( i , \cdot ) = {\sum }_{m = 1}^{F} {α}_{im} {s}^{m} ( i , \cdot ) \qquad ( 2 )$$

For any different i, different emphasis is put on those similarities. For example, if the user-selected query image is generally a scenery image, scene features are emphasized more by given them more weight when combining features, while if the query image is a group photo, facial features are emphasized more. This specific need of the features is reflected in the weight α, which has been referred to herein as the Intention.

In order to make different features work together for a specific image, the feature weights are adjusted locally according to different query images. As generally described above, a mechanism/algorithm is directed towards inferring local similarity by intention categorization. In general, as with human perception of natural images, images may be generally classified into typical intention classes, such as set forth in the following intentions table (note that less than all of these exemplified classes may be used in a given model, and/or other classes may be used instead of or in addition to these example classes):

| | |
|---|---|
| General Object | Images containing close-ups of |
| | general objects. |
| Simple Background Object | Object with Simple Background |
| Scene | Scenery images |
| People | Images with people in general |
| Portrait | Images containing a portrait, |
| | (more specific than the “People” |
| | intention). |
| Other | Images without a clear intention |
| | based on those above |

While virtually any type of classifier may be used, one example heuristic algorithm is described herein that was used to categorize each query image into an intention class, and to give specific feature combination to each category. In general, given a query image, its intention classification may be decided by the heuristic algorithm through a voting process with rules based on visual features of the query image. For example, the following rules may be used; (note however that the intention classification algorithm is not limited to such a rule-based algorithm):
1. If the image contains faces, increase score for “people” and “portrait”
2. If the image contains only one face with relatively a large size, and the face is near the center, increase score for “portrait”
3. If the image shows strong directionality (Kurtosis of EOH), increase score for “scene”, “general object”, and “object with simple background”
4. If the variance of CSpa feature is small, meaning color homogeneousness, increase score for “scene”
5. If edge energy is large, increase score for “general object” and “object with simple background”
6. If edge energy mainly distributed at the image center, increase score for “object with simple background”.

To unify these prior rules into a training framework, contribution functions rᵢ (•) are defined to denote a specific image feature's contribution to the intention i of query image Q. The final score of the intention i may be calculated as:

$${f}_{i} ( Q ) = {\sum }_{m = 1}^{F} {r}_{i} ( {Q}_{m} ) \qquad ( 3 )$$

which is a summation over the F features Qₘ of query image Q. Each of the contribution functions has the form

$$r = {e}^{- \frac{{( x - c )}^{2}}{2 {σ}^{2}}}$$

and is bell shaped, meaning that the score is only increased if x is in a specific range around c. Different intentions have different parameters, which can be trained by cross validation in a small training set to maximize the performance. The intention with the largest score is the intention for the query image Q.

With respect to intention-specific feature fusion, in each intention category, an optimal weight α is pre-trained to achieve a “best” performance in this intention:

$${α}^{*} = {arg max}_{α} {\sum }_{i} {p}_{i}^{k} [ {s}_{i} ( α ) ] \qquad ( 4 )$$

where sᵢ (α) is the similarity defined for image i by the weight α, and Pᵢ^{k}[•] is the precision of the top k images when queried by image i. The summation may be over all of the images in this intention category. This obtains an α that achieves the best performance based upon cross-validation in a randomly sampled subset of images.

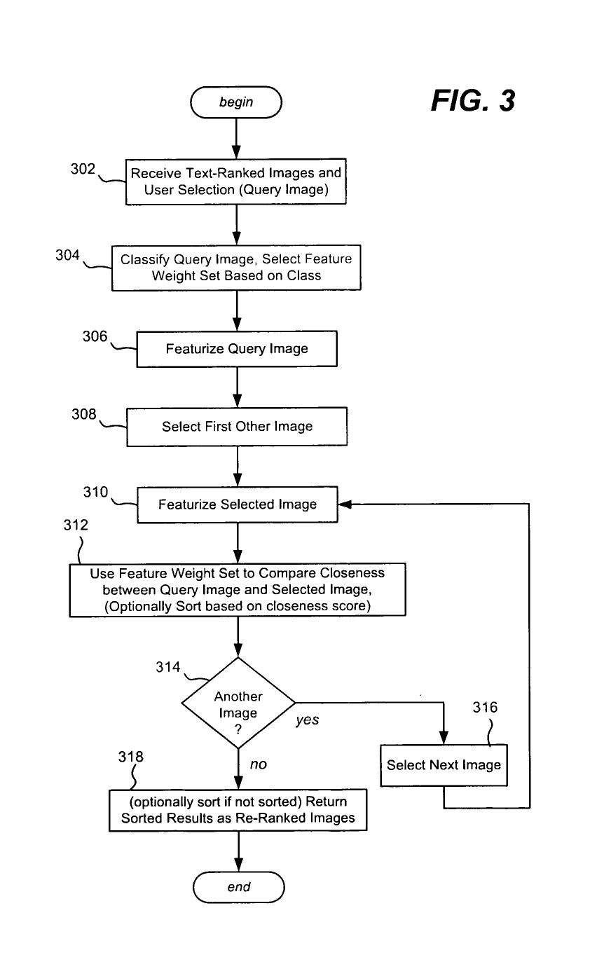

FIG. 3 summarizes the exemplified post-processing operations generally described above with reference to FIG. 2, beginning at step 302 which represents receiving the text-rank image data and the user selection, that is, the query image in this example. Step 304 classifies the query image based on its intention, which as described above may be dynamic or by retrieving the class from a cache. This class is used to select how features will be combined and compared, e.g., which set of weights to use.

Step 306 represents featurizing the query image into feature values, which also may be dynamically performed or by looking up feature values that were previously computed. Step 308 selects the first image to compare (as a comparison image) for similarity, which is repeated for each other image as a comparison image via steps 314 and 316.

As each image is processed, step 310 featurizes the selected image into its feature values. Step 312 compares these feature values with those of the query image, using the appropriate class-chosen feature weight set to emphasize certain features over others depending on the query image's intention class, as described above. For example, distance in vector space may be used to determine a closeness/similarity score. Note that the score may be used to rank the images relative to one another as the score is computed, and/or a sort may be performed after all scores are computed, before returning the images re-ranked according to the scores (e.g., at step 318).

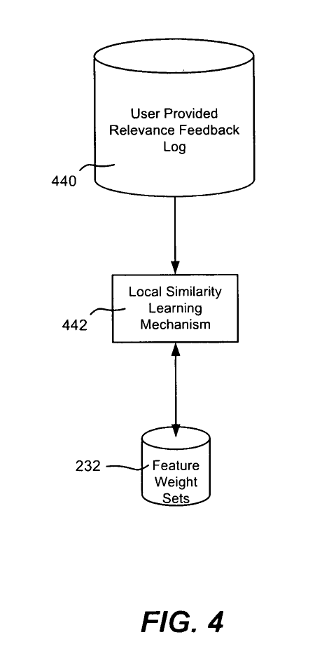

Turning to another aspect, to further improve the performance by tuning the feature weights for each image, additional information may be used. For example, in web-based applications, pair-wise similarity relationship information can be readily collected from user behavior data logs, such as relevance feedback data 440 (FIG. 4).

For example, if a user either explicitly or implicitly labels an image j as “relevant”, it means that the similarity between this image and the query image i is larger than the similarity between any other “irrelevant” image k and the query image i, namely, sᵢⱼ≧sᵢₖ. With a constant scale, an equivalent way to formulate this constraint is Sᵢⱼ−Sᵢₖ≧1. Such constraints reflect the user's perception of the images, which can be used to infer a useful weight to combine the clues from different features to make the ranking agree with the constraints as much as possible.

To extend the technology to new samples, samples that are similar “locally” need to have similar combination weights. To this end, a local similarity learning mechanism 442 may be used to adjust the feature weight sets 232. For example, αs that are not smooth are penalized, by minimizing the following energy term:

$${J}_{s} = \frac{1}{2} {\sum }_{i} {\sum }_{j} {s}_{i j} {‖ {α}_{i} - {α}_{j} ‖}^{2} = Tr ( {αΔα}^{T} ) \qquad ( 5 )$$

where α=[α₁, α₂, . . . , αₙ] is a matrix stacking weight of the images together, with each weight αᵢ=[αᵢ₁, αᵢ₂, . . . , α_{iF}]^{T}. The discrete Laplacian Δ can be calculated as:

Δ=D−S (6)

where S(i, j)=sᵢⱼ, sᵢⱼ=½[sᵢ (i, j)+sⱼ (i, j)], and D is a diagonal matrix with its ith diagonal element

$${D}_{ii} = {\sum }_{j} {S}_{ij} .$$

To learn from the pair-wise similarity relationship, an optimal weight α can be obtained by solving the following optimization problem:

$$min Tr ( {αΔα}^{T} ) + λ {‖ α ‖}^{2} \\ s . t . : {s}_{ij} - {s}_{ik} \geq 1 , ∀ ( i , j , k ) ∈ C \qquad ( 7 )$$

where C is the set of constraints with elements (i,j,k) satisfying sᵢⱼ−sᵢₖ≧1, and the second term is the regularization term to control the complexity of the solution. Here the norm |•| may be an L2 norm for robustness, or an L1 norm for sparseness.

If taking a Frobenius norm as the regularization term, then ∥α∥_{F}²=Tr(α^{T}α)=Tr(αα^{T}). The slack variable ξijk can be added for each constraint (i,j,k), whereby the optimization problem can be further simplified to:

$${min}_{α , ξ} Tr ( α ( Δ + λ I ) {α}^{T} ) + γ {\sum }_{i j k} {ξ}_{i j k} \\ s . t . : {s}_{i j} - {s}_{i k} \geq 1 - {ξ}_{i j k} , ∀ ( i , j , k ) ∈ C , \\ ξ ≽ 0 , α ≽ 0 \qquad ( 8 )$$

which is a convex optimization problem with respect to ξ and α, and can be solved efficiently; known iterative algorithms can also be used. Note that in this example optimization, Δ depends on α, so a mechanism can solve for optimal α by iterating between solving the optimization problem in Equation (8) and updating Δ0 according to Equation (6) until convergence.

With respect to extending to new images, consider a new query image j without any relevance feedback log. Its optimal weight α*ⱼ can be inferred from its nearest neighbor in the trained exemplars; e.g., the weight of this nearest neighbor may be taken as the optimal weight. If relevance feedback is later gathered after some user interaction, the intention of this image may be updated by taking the initial value of αⱼ as α*ⱼ, and solving the following optimization problem:

$${min}_{{α}_{j} , ξ} {‖ {α}_{j} - {α}_{j}^{*} ‖ }_{2}^{2} + γ {\sum }_{i j k} {ξ}_{i j k} \\ s . t . : {s}_{i j} - {s}_{i k} \geq 1 - {ξ}_{i j k} , ∀ ( i , j , k ) ∈ {C}_{j} , \\ ξ ≽ 0 , {α}_{j} ≽ 0 \qquad ( 9 )$$

where Cⱼ is the set of all available constraints related to the image.

Relevance feedback is especially suitable for web-based image search engines, where user click-through behavior is readily available for analysis, and considerable amounts of similarity relationships may be easily obtained. In such a scenario, the weights associated with each image may be updated in an online manner, while gradually increasing the trained exemplars in the database. As more and more user behavior data becomes available, the performance of the search engine can be significantly improved.

In sum, there is provided a practical yet effective way to improve the image search engine performance with respect to ranking images in a relevant way, via an intention categorization model that integrates a set of complementary features based on a query image. Further tuning by considering each image specifically results in an improved user experience.

### Exemplary Operating Environment

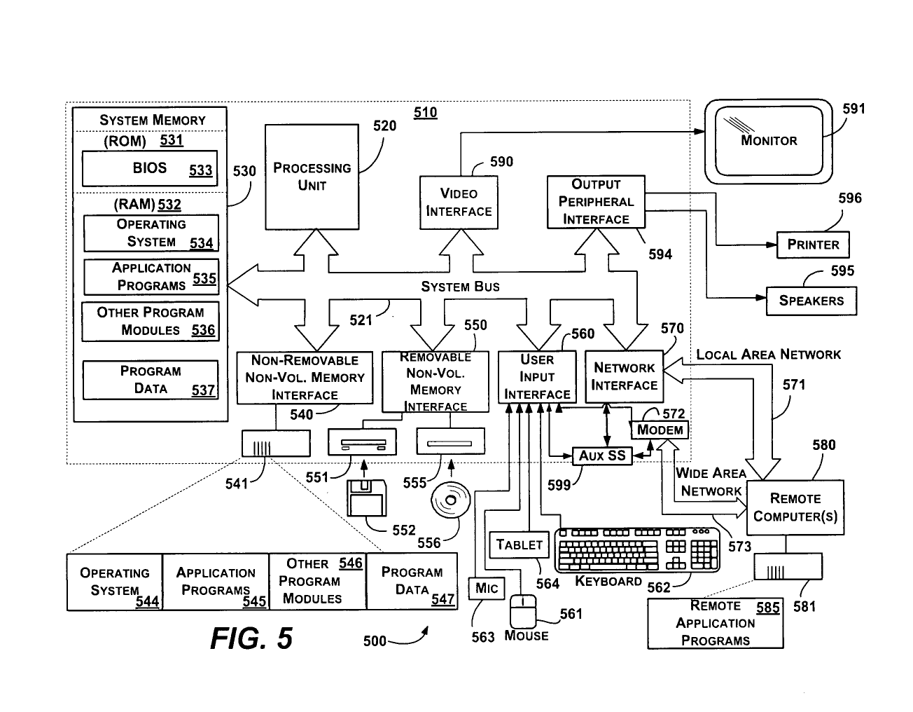

FIG. 5 illustrates an example of a suitable computing and networking environment 500 on which the examples of FIGS. 1-4 may be implemented. For example, the adaptive image post-processing mechanism 112 of FIGS. 1 and 2 may be implemented in the computer system 510, with the client represented by the remote computers 580. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the exemplary operating environment 500.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, embedded systems, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an exemplary system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 595, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are exemplary and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising:
receiving user selection data with respect to an image selected from a plurality of images, the selection data including a query image;
determining similarity scores for other images of the plurality based on each other image's similarity with the query image, in which the similarity scores are computed at least in part based upon intention class information associated with the query image; and
returning results corresponding to the images ranked based upon the similarity scores.

2. The method of claim 1 wherein receiving the user selection data comprises receiving a user selection corresponding to the query image based upon text-ranked image results.

3. The method of claim 1 further comprising, classifying the query image into a class, and selecting the intention class information based on the class.

4. The method of claim 1 further comprising, featurizing the query image into first feature values and featurizing each other image into second feature values, and wherein determining the similarity scores comprises comparing data corresponding to the first and second feature values.

5. The method of claim 4 wherein comparing the data corresponding to the first and second feature values comprises weighing parts of the feature values relative to one another based upon the intention class information.

6. The method of claim 1 further comprising, tuning the intention class information based upon relevance feedback.

7. In a computing environment, a system comprising, an image processing mechanism, including a categorization mechanism that obtains an intention class for a selected image, a featurizer mechanism that obtains first feature values for the selected image and second feature values for another image, and a feature comparing mechanism coupled to the categorization mechanism and to the featurizer mechanism, the feature comparing mechanism configured to use the intention class to select a comparison mechanism, and use the comparison mechanism to compute a similarity score between the selected image and the other image using the first feature values and the second feature values.

8. The system of claim 7 wherein the selected image and the other image are provided by an Internet search engine coupled to the image processing mechanism.

9. The system of claim 7 wherein the image processing mechanism further includes a ranking mechanism that ranks the similarity score relative to at least one other similarity score obtained by processing another image.

10. The system of claim 7 further comprising a cache coupled to the image processing mechanism, wherein the featurizer mechanism obtains at least some of the first feature values, or at least some of the second feature values, or at least some of both the first feature values and the second feature values from the cache.

11. The system of claim 7 further comprising a cache coupled to the image processing mechanism, wherein the categorization mechanism obtains the intention class from the cache.

12. The system of claim 7 further comprising means for tuning the comparison mechanism based upon relevance feedback.

13. The system of claim 11 wherein the comparison mechanism comprises a set of feature weights selected from among a plurality of sets of feature weights.

14. The system of claim 13 wherein the features include color signature, color spatialet, gist, Daubechies wavelet, SIFT, multi-layer rotation invariant edge orientation histogram, histogram of gradient, or facial feature face, or any combination of color signature, color spatialet, gist, Daubechies wavelet, SIFT, multi-layer rotation invariant edge orientation histogram, histogram of gradient, or facial feature face.

15. The system of claim 13 wherein the classes include general object, simple background object, scene, people, portrait or other, or any combination of general object, simple background object, scene, people, portrait or other.

16. One or more computer-readable media having computer-executable instructions, which when executed perform steps, comprising:
(a) receiving data corresponding to a set of images and one selected image;
(b) classifying the selected image into an intention class;
(c) choosing a comparison mechanism from among plurality of available comparison mechanisms based upon the intention class;
(d) featurizing the selected image into first feature values;
(e) for each image other than the selected image, taking that image as a comparison image, featurizing that comparison image into second feature values, and comparing the first feature values and the second feature values using the comparison mechanism chosen in step (c) to determine and associate a similarity score of the comparison image with respect to that comparison image; and
(f) returning data corresponding to the comparison images re-ranked relative to one another based on the associated similarity score determined for each image.

17. The one or more computer-readable media of claim 16 wherein choosing the comparison mechanism comprises selecting a set of feature weights from among different sets of feature weights based upon the intention class.

18. The one or more computer-readable media of claim 16 having further computer-executable instructions comprising, changing at least one comparison mechanism based upon user relevance feedback.

19. The one or more computer-readable media of claim 16, wherein the features include color signature, color spatialet, gist, Daubechies wavelet, SIFT, multi-layer rotation invariant edge orientation histogram, histogram of gradient, or facial feature face, or any combination of color signature, color spatialet, gist, Daubechies wavelet, SIFT, multi-layer rotation invariant edge orientation histogram, histogram of gradient, or facial feature face.

20. The one or more computer-readable media of claim 16, wherein the classes include general object, simple background object, scene, people, portrait or other, or any combination of general object, simple background object, scene, people, portrait or other.
